(19) United States
(12) Patent Application Publication
(10) Pub. No.: US 2020/0125287 A1
(43) Pub. Date: Apr. 23, 2020

(54) METHOD AND SYSTEM FOR DEPLOYING SOLID STATE DRIVE AS EXTENSION OF RANDOM ACCESS MEMORY

(71) Applicant: IQLECT Software Solutions Pvt Ltd., Bangalore (IN)

(72) Inventor: Sachin SINHA, Bangalore (IN)

(21) Appl. No.: 16/168,673

(22) Filed: Oct. 23, 2018

(51) Int. Cl. G06F 3/06; G06F 15/18

(52) U.S. Cl. CPC G06F 3/0652; G06F 3/0608; G06F 15/18; G06F 3/0611; G06F 3/0685; G06F 3/0656

(57) ABSTRACT

The present disclosure provides a system for deploying a solid state drive as an extension of a random access memory. The system programs an I/O layer on top of the solid state drive. Further, the system installs the solid state drive with the programmed I/O layer between the random access memory and a hard disk drive. Also, the system serves a plurality of read/write requests occurring for a set of data at the I/O layer in pre-defined criteria. Further, the pre-defined criteria include sequentially writing the set of data occurred at the I/O layer to the solid state drive. Furthermore, the pre-defined criteria include reading the set of data directly from the solid state drive instead of the hard disk drive.

### TECHNICAL FIELD

The present disclosure relates to the field of memory technology, and in particular, relates to a method and system for deploying solid state drive as extension of random access memory.

### INTRODUCTION

Over the past few years, there is an exponential growth in amount of data generated. The exponential growth in amount of the data generated is due to advent of technologies that use machines to generate and deal with data. Also, the increase in technologies such as Internet of things, Machine learning, Big data and Artificial Intelligence contribute hugely on development of large amount of the data. In addition, data analytics is happening at a rapid pace that utilizes a large amount of the data. The growth in the data over the past two years is around 10× and the growth in hardware of a computer system is 2×. Hence, the growth in data is 5× as compared to growth in hardware of a computer system. As a result, there is a huge gap that is gradually increasing between the data and hardware of the computer system. In an example, technologies such as Internet of things and Artificial Intelligence are pushing for data analysis in real-time. Also, use of advanced use cases in field of data analytics demand real-time decision making. As a result, there occurs a requirement to expand hardware constantly to cope up with increasing gap between the data and hardware of the computer system. However, addition of hardware constantly is usually costlier and inelastic to perform. Also, addition of hardware constantly consumes lot of time and is not preferable.

To access data with higher speed, we typically use a random access memory. The random access memory is form of data storage that stores data and machine code currently in use. The random access memory allows data to be read or written in almost same amount of time irrespective of physical location of data inside the random access memory. However, the random access memory is costlier and inelastic. As a result, for every extra byte of the generated data for processing, we need to add same amount of the random access memory. However, this approach becomes very resistive in nature.

Traditionally, we use a hard disk drive and a solid state drive for data storage purposes. The hard disk drive is data storage device that uses magnetic storage to store and retrieve digital data. The hard disk drive uses one or more rigid rapidly rotating disks (platters) coated with magnetic material. On the other hand, the solid state drive is solid-state storage device that uses integrated circuit assemblies as memory to store data persistently in the computer system. Also, the solid state drive primarily uses electronic interfaces compatible with traditional block input/output hard disk drives.

However, the hard disk drive and the solid state drive works slower as compared to the random access memory. Moreover, the hard disk drive works slower as compared to the solid state drive. Further, the hard disk drive is magnetic device that has a seek time of about 8-10 milliseconds. However, the solid state drive has seek time of around 0 milliseconds. Furthermore, the solid state drive has throughput more than 2×+ of that of the hard disk drive. In addition, the solid state drive can be simply used as block device. However, the solid state drive and the hard disk drive are cheaper than the random access memory. In a nutshell, the solid state drive lies somewhere in between the random access memory and the hard disk drive in terms of cost, speed and performance.

At present, we use the solid state drive in association with the hard disk drive. The solid state drive is treated as the hard disk drive to store the data. Further, the solid state drive may act as caching layer and then push the data in the hard disk drive. Furthermore, the solid state drive may act as block device without any file system. However, the solid state drive associated with the hard disk drive works slower and cannot process the generated data with desired speed. In addition, the solid state drive associated with the hard disk drive does not provide performance as compared to performance provided by the random access memory. As a result, the solid state drive associated with the hard disk drive is not suitable for data analytics, especially real-time. In addition, the solid state drive is treated as block device to expand the hard disk drive.

In light of the above mentioned discussion, there is a constant need for faster and high volume data ingestion. In addition, there is a constant need for faster data processing and faster extraction of insights which requires faster data storage and most of time overflowing the memory to get stored on the disk in order to achieve continuous processing.

### SUMMARY

In a first example, a computer-implemented method is provided. The computer-implemented method provides expansion of a random access memory by deploying a solid state drive in extension with the already installed random access memory. The solid state drive is deployed in extension with the random access memory to reduce hardware cost and increase elasticity. The computer-implemented method includes a first step of programming an I/O layer on top of the solid state drive. The computer-implemented method includes another step of installing the solid state drive with the programmed I/O layer between the random access memory and a hard disk drive. The computer-implemented method includes yet another step of serving a plurality of read/write requests occurring for a set of data at the I/O layer in a pre-defined criteria. The I/O layer is used to handle the plurality of read/write requests for the set of data. The I/O layer handles the plurality of read/write requests using one or more background threads. The solid state drive acts as extension of the already installed random access memory. The plurality of read/write requests are served based on a plurality of prediction algorithms. The pre-defined criteria include sequentially writing the set of data occurred at the I/O layer to the solid state drive. The pre-defined criteria include reading the set of data directly from the solid state drive instead of the hard disk drive. The set of data is written sequentially to the solid state drive to increase life cycle of the solid state drive. The set of data is read directly from the solid state drive to increase speed and performance of the read operation.

In an embodiment of the present disclosure, the pre-defined criteria include writing the set of data in a solid state drive pool present in the solid state drive. The pre-defined criteria include flushing the set of data in the hard disk drive. The set of data is written in the solid state drive pool if there is no space in a buffer pool present in the random access memory. The set of data is flushed to the hard disk drive if there is no space in the solid state drive pool.

In an embodiment of the present disclosure, the pre-defined criteria include reading the set of data from the solid state drive pool present in the solid state drive. The pre-defined criteria include reading the set of data from the hard disk drive. The set of data is read from the solid state drive pool if the set of data is present in the solid state drive pool. The set of data is read from the hard disk drive if the set of data is not present in the solid state drive pool.

In an embodiment of the present disclosure, the flushing of a set of pages to the hard disk drive from the solid state drive pool includes a first step of checking if the solid state drive is full. The method includes a second step of locking the solid state drive pool. The method includes a third step of executing second last step. The method includes a fourth step of computing size of the solid state drive pool to be flushed to the hard disk drive. The method includes a fifth step of collecting a set of headers from LRU for size. The method includes a sixth step of resetting EOF and other pointers to pages. The method includes a seventh step of marking chunk of area to be flushed. The method includes an eighth step of copying chunk of area to another temp memory. The method includes a ninth step of removing the set of headers from hash table and LRU. The method includes a tenth step of unlocking the solid state drive pool for append only. The method includes an eleventh step of sorting the set of headers by sum of FILE ID and BLOCK ID. The method includes a twelfth step of doing vector write of all pages to the hard disk drive. The method includes a thirteenth step of returning number of the set of headers flushed. The method includes a fourteenth step of unlocking the solid state drive pool for read. The method includes a fifteenth step of sleeping if it is background work. The method includes a sixteenth step of repeating above mentioned steps. The solid state drive pool is locked if the solid state drive is full. The fifteenth step is executed if the solid state drive pool is not full.

In an embodiment of the present disclosure, the writing of the set of headers to the solid state drive pool includes a first step of checking whether the buffer pool is full. The method includes another step of locking the buffer pool. The method includes yet another step of executing second last step. The method includes yet another step of collecting the set of headers from LRU with DP mark. The method includes yet another step of repeating steps of flushing of the set of pages to the hard disk drive from the solid state drive pool. The method includes yet another step of checking if there is enough space in the solid state drive pool. The method includes yet another step of locking the solid state drive pool for write. The method includes yet another step of repeating steps of flushing of the set of pages to the hard disk drive from the solid state drive pool. The method includes yet another step of appending the solid state drive pool area for given size. The method includes yet another step of resetting the set of pointers. The method includes yet another step of putting the set of headers in hash table. The method includes yet another step of putting the set of headers in LRU list. The method includes yet another step of unlocking the solid state drive pool for write. The method includes yet another step of returning n headers to BP_BW. The method includes yet another step of sleeping. The method includes yet another step of repeating above mentioned steps. The buffer pool is locked if the buffer pool is full. The second last step is executed if the buffer pool is not full. The solid state drive pool is locked if there is enough space in the solid state drive pool. The steps of flushing of the set of pages to the hard disk drive from the solid state drive pool are repeated if there is not enough space in the solid state drive pool.

In an embodiment of the present disclosure, wherein size of the solid state drive should be less than 16× of size of the random access memory to get performance of 4× of size of the random access memory.

In an embodiment of the present disclosure, wherein life of the solid state drive is extended below range of 16× or 32×

In an embodiment of the present disclosure, the solid state drive of any size is deployed in extension with the random access memory of any size.

In an embodiment of the present disclosure, wherein the plurality of prediction algorithms includes absolute prediction, heuristic based prediction and machine learning based prediction.

In a second example, a computer system is provided. The computer system includes a random access memory, a hard disk drive and a solid state drive. The solid state drive is deployed to act as extension of the already installed random access memory. The solid state drive is deployed to work in background with the random access memory. The solid state drive acts as an extension to the already installed random access memory by performing a method. The method includes a first step of programming an I/O layer on top of the solid state drive. The method includes another step of installing the solid state drive with the programmed I/O layer between the random access memory and the hard disk drive. The method includes yet another step of serving a plurality of read/write requests occurring for a set of data at the I/O layer in pre-defined criteria. The I/O layer is used to handle the plurality of read/write requests for the set of data. The I/O layer handles the plurality of read/write requests using one or more background threads. The solid state drive acts as extension of the already installed random access memory. The plurality of read/write requests are served based on a plurality of prediction algorithms. The pre-defined criteria include sequentially writing the set of data occurred at the I/O layer to the solid state drive. The pre-defined criteria include reading the set of data directly from the solid state drive instead of the hard disk drive. The set of data is written sequentially to the solid state drive to increase life cycle of the solid state drive. The set of data is read directly from the solid state drive to increase speed and performance of the read operation.

In an embodiment of the present disclosure, the pre-defined criteria include writing the set of data in a solid state drive pool present in the solid state drive. The pre-defined criteria include flushing the set of data in the hard disk drive. The set of data is written in the solid state drive pool if there is no space in a buffer pool present in the random access memory. The set of data is flushed to the hard disk drive if there is no space in the solid state drive pool.

In an embodiment of the present disclosure, the pre-defined criteria include reading the set of data from the solid state drive pool present in the solid state drive. The pre-defined criteria include reading the set of data from the hard disk drive. The set of data is read from the solid state drive pool if the set of data is present in the solid state drive pool. The set of data is read from the hard disk drive if the set of data is not present in the solid state drive pool.

In an embodiment of the present disclosure, the flushing of a set of pages to the hard disk drive from the solid state drive pool includes a first step of checking if the solid state drive is full. The method includes a second step of locking the solid state drive pool. The method includes a third step of executing second last step. The method includes a fourth step of computing size of the solid state drive pool to be flushed to the hard disk drive. The method includes a fifth step of collecting a set of headers from LRU for size. The method includes a sixth step of resetting EOF and other pointers to pages. The method includes a seventh step of marking chunk of area to be flushed. The method includes an eighth step of copying chunk of area to another temp memory. The method includes a ninth step of removing the set of headers from hash table and LRU. The method includes a tenth step of unlocking the solid state drive pool for append only. The method includes an eleventh step of sorting the set of headers by sum of FILE ID and BLOCK ID. The method includes a twelfth step of doing vector write of all pages to the hard disk drive. The method includes a thirteenth step of returning number of the set of headers flushed. The method includes a fourteenth step of unlocking the solid state drive pool for read. The method includes a fifteenth step of sleeping if it is background work. The method includes a sixteenth step of repeating above mentioned steps. The solid state drive pool is locked if the solid state drive is full. The fifteenth step is executed if the solid state drive pool is not full.

In an embodiment of the present disclosure, the writing of the set of headers to the solid state drive pool includes a first step of checking whether the buffer pool is full. The method includes another step of locking the buffer pool. The method includes yet another step of executing second last step. The method includes yet another step of collecting the set of headers from LRU with DP mark. The method includes yet another step of repeating steps of flushing of the set of pages to the hard disk drive from the solid state drive pool. The method includes yet another step of checking if there is enough space in the solid state drive pool. The method includes yet another step of locking the solid state drive pool for write. The method includes yet another step of repeating steps of flushing of the set of pages to the hard disk drive from the solid state drive pool. The method includes yet another step of appending the solid state drive pool area for given size. The method includes yet another step of resetting the set of pointers. The method includes yet another step of putting the set of headers in hash table. The method includes yet another step of putting the set of headers in LRU list. The method includes yet another step of unlocking the solid state drive pool for write. The method includes yet another step of returning n headers to BP_BW. The method includes yet another step of sleeping. The method includes yet another step of repeating above mentioned steps. The buffer pool is locked if the buffer pool is full. The second last step is executed if the buffer pool is not full. The solid state drive pool is locked if there is enough space in the solid state drive pool. The steps of flushing of the set of pages to the hard disk drive from the solid state drive pool are repeated if there is not enough space in the solid state drive pool.

In an embodiment of the present disclosure, wherein size of the solid state drive should be less than 16× of size of the random access memory to get performance of 4× of size of the random access memory.

In an embodiment of the present disclosure, wherein life of the solid state drive is extended below range of 16× or 32×

In an embodiment of the present disclosure, wherein the plurality of prediction algorithms comprises of absolute prediction, heuristic based prediction and machine learning based prediction.

In a third example, a computer-readable storage medium is provided. The computer-readable storage medium encodes computer executable instructions that, when executed by at least one processor, performs a method. The method provides expansion of a random access memory by deploying a solid state drive in extension with the already installed random access memory. The solid state drive is deployed in extension with the random access memory to reduce cost and increase elasticity. The method includes a first step of programming an I/O layer on top of the solid state drive. The method includes another step of installing the solid state drive with the programmed I/O layer between the random access memory and a hard disk drive. The method includes yet another step of serving a plurality of read/write requests occurring for a set of data at the I/O layer in pre-defined criteria. The I/O layer is used to handle the plurality of read/write requests for the set of data. The I/O layer handles the plurality of read/write requests using one or more background threads. The one or more background threads are used to write the set of data in the solid state drive from the random access memory. The solid state drive acts as extension of the already installed random access memory. The plurality of read/write requests are served based on a plurality of prediction algorithms. The plurality of prediction algorithms includes absolute prediction, heuristic based prediction and machine learning based prediction. The plurality of read/write requests are served at the I/O layer of the solid state drive. The pre-defined criteria include sequentially writing the set of data occurred at the I/O layer to the solid state drive. The pre-defined criteria include reading the set of data directly from the solid state drive instead of the hard disk drive. The set of data is written sequentially to the solid state drive to increase life cycle of the solid state drive. The set of data is read directly from the solid state drive to increase speed and performance of the read operation.

### BRIEF DESCRIPTION OF THE DRAWINGS

Having thus described the invention in general terms, references will now be made to the accompanying figures, wherein:

FIG. 1 illustrates a system for deploying a solid state drive as extension of a random access memory, in accordance with various embodiments of the present disclosure;

FIG. 2 illustrates an interaction between an application, the random access memory, the solid state drive and a hard disk drive, in accordance with various embodiments of the present disclosure;

FIG. 3 illustrates a flow chart for performing a method for write request on a set of data, in accordance with various embodiments of the present disclosure;

FIG. 4 illustrates a flow chart for performing a method for read request on the set of data, in accordance with various embodiments of the present disclosure;

FIGS. 5A and 5B illustrate a flow chart for flushing a set of pages from the solid state drive pool to the hard disk drive, in accordance with various embodiments of the present disclosure;

FIGS. 6A and 6B illustrate a flow chart for flushing a set of headers to the solid state drive pool, in accordance with various embodiments of the present disclosure; and

FIGS. 7A and 7B illustrate a flow chart for deploying the solid state drive as extension of the random access memory, in accordance with various embodiments of the present disclosure.

It should be noted that the accompanying figures are intended to present illustrations of exemplary embodiments of the present disclosure. These figures are not intended to limit the scope of the present disclosure. It should also be noted that accompanying figures are not necessarily drawn to scale.

### DETAILED DESCRIPTION

In the following description, for purposes of explanation, numerous specific details are set forth in order to provide a thorough understanding of the present technology. It will be apparent, however, to one skilled in the art that the present technology can be practiced without these specific details. In other instances, structures and devices are shown in block diagram form only in order to avoid obscuring the present technology.

Reference in this specification to “one embodiment” or “an embodiment” means that a particular feature, structure, or characteristic described in connection with the embodiment is included in at least one embodiment of the present technology. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

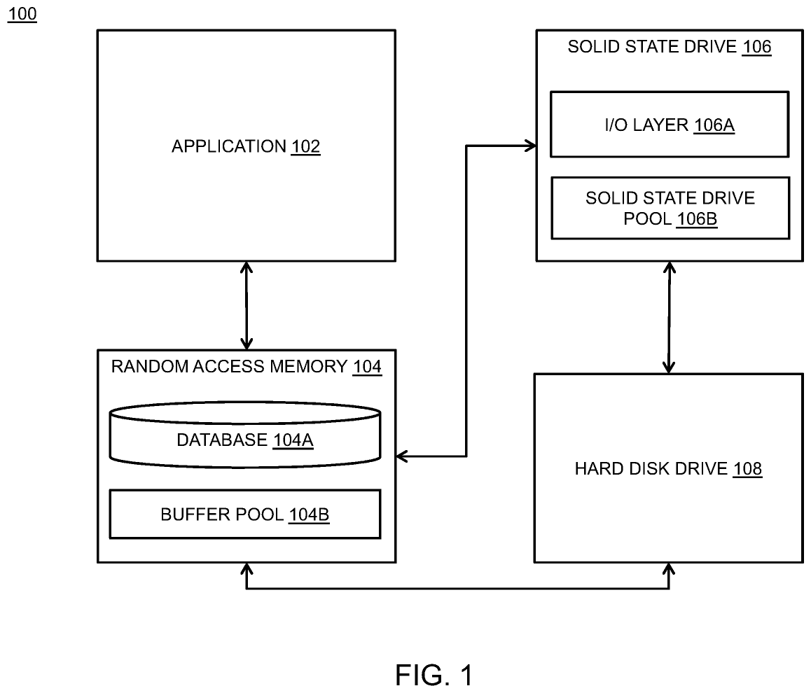

FIG. 1 illustrates a general overview of a system 100 for deploying a solid state drive 106 as extension of a random access memory 104, in accordance with various embodiments of the present disclosure. The system 100 includes an application 102, the random access memory 104, the solid state drive 106 and a hard disk drive 108. Further, the random access memory 104 includes a database 104a and a buffer pool 104b. Furthermore, the solid state drive 106 includes an I/O layer 106a and a solid state drive pool 106b.

The system 100 includes the application 102. The application 102 is installed in a computer system. The application 102 is any software code that is basically programmed to interact with hardware elements of the computer system. The term hardware elements here refer to a plurality of memory types installed inside the computer system. Moreover, the application 102 is used to access, read, update and modify data stored in hardware elements of the computer system. In an embodiment of the present disclosure, the application 102 is any software code that may interact with the random access memory 104 of the computer system.

In an embodiment of the present disclosure, the application 102 is a DBMS application. The term DBMS stands for database management system. In general, the DBMS is software subsystem used for storing, retrieving and manipulating data stored in the database 104a. In addition, the data includes records, data pages, data containers, data objects and the like. In general, the database 104a is an organized collection of data. In an example, the application 102 includes MySQL, MS-Access, Oracle Database, BangDB, NoSQL and the like. Also, the application 102 provides a user interface to a user to interact with hardware elements of the computer system. The user interface may include Graphical User Interface (GUI), Application Programming Interface (API), and the like. The user interface helps to send and receive user commands and data. In addition, the user interface serves to display or return results of operation from the application 102. In an embodiment of the present disclosure, the user interface is part of the application 102.

In an embodiment of the present disclosure, the application 102 is installed at a server. In another embodiment of the present disclosure, the application 102 is installed at a plurality of servers. In an example, the plurality of servers may include database server, file server, application server and the like. The plurality of servers communicates with each other using a communication network. In general, the communication network is part of network layer responsible for connection of two or more servers. Further, the communication network may be any type of network. In an embodiment of the present disclosure, the type of communication network is wireless mobile network. In another embodiment of the present disclosure, the type of communication network is wired network with a finite bandwidth. In yet another embodiment of the present disclosure, the type of communication network is combination of wireless and wired network for optimum throughput of data transmission. In yet another embodiment of the present disclosure, the type of communication network is an optical fiber high bandwidth network that enables a high data rate with negligible connection drops.

The computer system is any computer system which mainly comprises the random access memory 104, the hard disk drive 108 and a display panel. In an embodiment of the present disclosure, the computer system is a portable computer system. In an example, the portable computer system includes laptop, smartphone, tablet and the like. In an example, the smartphone may be an Apple smartphone, an Android-based smartphone, a Windows-based smartphone and the like. In another embodiment of the present disclosure, the computer system is a fixed computer system. In an example, the fixed computer system includes a desktop, a workstation PC and the like.

Further, the computer system is associated with the user. The user is a person who wants to deploy the solid state drive 106 as an extension of the already installed random access memory 104 in the computer system. Also, the user operates the application 102 to interact with hardware elements of the computer system.

In addition, the computer system requires an operating system to install and load the application 102 in the computer system. In general, the operating system is system software that manages hardware and software resources and provides common services for computer programs. In addition, the operating system acts as an interface for the application 102 installed in the computer system to interact with the random access memory 104 or hardware of the computer system. In an embodiment of the present disclosure, the operating system installed in the computer system is a mobile operating system. In another embodiment of the present disclosure, the computer system runs on any suitable operating system designed for the portable computer system. In an example, the mobile operating system includes but may not be limited to Windows operating system from Microsoft, Android operating system from Google, iOS operating system from Apple, Symbian based operating system from Nokia, Bada operating system from Samsung Electronics and BlackBerry operating system from BlackBerry. In an embodiment of the present disclosure, the operating system is not limited to the above mentioned operating systems. In addition, the computer system runs on any version of the above mentioned operating systems.

In another embodiment of the present disclosure, the computer system runs on any suitable operating system designed for fixed computer system. In an example, the operating system installed in the computer system is Windows from Microsoft. In another example, the operating system installed in the computer system is Mac from Apple. In yet another example, the operating system installed in the computer system is Linux based operating system. In yet another example, the operating system installed in the computer system may be UNIX, Kali Linux, and the like.

In an embodiment of the present disclosure, the computer system runs on any version of Windows operating system. In another embodiment of the present disclosure, the computer system runs on any version of Mac operating system. In another embodiment of the present disclosure, the computer system runs on any version of Linux operating system. In yet another embodiment of the present disclosure, the computer system runs on any version of the above mentioned operating systems.

In an embodiment of the present disclosure, the computer system includes the display panel to interact with the application 102. Also, the computer system includes the display panel to display results fetched from the application 102. In an embodiment of the present disclosure, the computer system includes an advanced vision display panel. The advanced vision display panels include OLED, AMOLED, Super AMOLED, Retina display, Haptic touchscreen display and the like. In another embodiment of the present disclosure, the computer system includes a basic display panel. The basic display panel includes but may not be limited to LCD, IPS-LCD, capacitive touchscreen LCD, resistive touchscreen LCD, TFT-LCD and the like.

The system includes the random access memory 104. In general, the random access memory 104 is form of data storage that stores data and machine code currently in use. The random access memory 104 allows data to be read or written in almost same amount of time irrespective of physical location of data inside the random access memory 104. In general, the random access memory 104 is faster than the solid state drive 106 and the hard disk drive 108. The random access memory 104 installed inside the computer system may be of any suitable size as per requirement of the user. In an example, the random access memory 104 is of 4 GB. In another example, the random access memory 104 is of 8 GB. In yet another example, the random access memory 104 is of 16 GB.

The random access memory 104 includes the database 104a. The database 104a present in the random access memory 104 is an IMDB. The term IMDB stands for in-memory database. In general, the IMDB is a database whose data is stored in main memory to facilitate faster response times. In addition, the random access memory 104 includes the buffer pool 104b of the database 104a. In general, the buffer pool 104b is portion of main memory space allocated by database manager. In general, the buffer pool 104b is allocated to cache table and index data from disk. In general, database manager is a computer program, or a set of computer programs, that provide basic database management functionalities including creation and maintenance of databases.

In an embodiment of the present disclosure, the database 104a is stored in the solid state drive 106 of the computer system. In another embodiment of the present disclosure, the database 104a is stored in the hard disk drive 108 of the computer system. In another embodiment of the present disclosure, the database 104a is stored in the random access memory 104, the solid state drive 106 and the hard disk drive 108 of the computer system.

The system 100 includes the solid state drive 106 deployed with the random access memory 104. In general, the solid state drive 106 is solid-state storage device that uses integrated circuit assemblies as memory to store data persistently in the computer system. Also, the solid state drive 106 primarily uses electronic interfaces compatible with traditional block input/output hard disk drives. In addition, the solid state drive 106 includes the solid state drive pool 106b. Also, the solid state drive 106 includes the I/O layer 106a. The I/O layer 106a is programmed on top of the solid state drive 106. The solid state drive 106 installed inside the computer system may be of any suitable size as per requirement of the user. In an example, the solid state drive 106 is of 32 GB. In another example, the solid state drive 106 is of 64 GB. In yet another example, the solid state drive 106 is of 128 GB.

Further, the solid state drive 106 is connected with the hard disk drive 108. In general, the hard disk drive 108 is data storage device that uses magnetic storage to store and retrieve digital data. The hard disk drive 108 uses one or more rigid rapidly rotating disks or platters coated with magnetic material. In addition, the hard disk drive 108 is connected with the random access memory 104 of the computer system. The hard disk drive 108 installed inside the computer system may be of any suitable size as per requirement of the user. In an example, the hard disk drive 108 is of 512 GB. In another example, the hard disk drive 108 is of 1 TB. In yet another example, the hard disk drive 108 is of 2 TB.

Initially, the I/O layer 106a is programmed on top of the solid state drive 106. The I/O layer 106a here refers to input/output layer. The I/O layer 106a is used to handle a plurality of read/write requests for a set of data. In an embodiment of the present disclosure, the plurality of read/write requests is generated from the application 102. Further, the plurality of read/write requests is served by the random access memory 104 of the computer system. Furthermore, the plurality of read/write requests occurs at the I/O layer 106a of the solid state drive 106. The set of data refers to any data that is to be read from the solid state drive 106. Also, the set of data refers to any data that is to be written in the solid state drive 106. The I/O layer 106a determines whether the request is a read request or a write request. The I/O layer 106a handles the plurality of read/write requests using one or more background threads.

Further, the solid state drive 106 with the programmed I/O layer 106a is installed between the random access memory 104 and the hard disk drive 108 of the computer system. The solid state drive 106 acts as extension of the already installed random access memory 104. The solid state drive 106 of any size is deployed with the random access memory 104 of any size. In an example, the solid state drive 106 of 128 GB is deployed with the random access memory 104 of 32 GB. In another example, the solid state drive 106 of 64 GB is deployed with the random access memory 104 of 4 GB.

Furthermore, the I/O layer 106a serves the plurality of read/write requests occurring for the set of data in pre-defined criteria. In addition, the plurality of read/write requests is served based on a plurality of prediction algorithms. The plurality of prediction algorithms includes absolute prediction, heuristic based prediction and machine learning based prediction. However, the plurality of prediction algorithms are not limited to above mentioned prediction algorithms. The plurality of prediction algorithms are used to predict data that is not going to be used in near future. In an embodiment of the present disclosure, the plurality of prediction algorithms search data that is kept idle for a large time in the random access memory 104. Further, the plurality of prediction algorithms predict that this data is not going to be used in near future and writes data to the solid state drive 106. In another embodiment of the present disclosure, the plurality of prediction algorithms search data that is kept idle for a large time in the solid state drive 106. Further, the plurality of prediction algorithms predicts that this data is not going to be used in near future and flushes data to the hard disk drive 108.

In an embodiment of the present disclosure, the plurality of prediction algorithms works along with the one or more background threads. The plurality of prediction algorithms predicts data that is not going to be used in near future. Further, the one or more background threads retain data that is going to be used in near future in the random access memory 104 of the computer system. In addition, the one or more background threads write the set of data in the solid state drive 106 silently without disturbing operations of the random access memory 104. Further, the one or more background threads flush the set of data in the hard disk drive 108 silently without disturbing other operations of the computer system.

The pre-defined criteria used by the I/O layer 106a includes sequential writing of the set of data occurred at the I/O layer 106a to the solid state drive 106. The set of data is written sequentially to the solid state drive 106 to increase life cycle of the solid state drive 106. In addition, the pre-defined criteria used by the I/O layer 106a includes reading of the set of data occurred at the I/O layer 106a directly from the solid state drive 106 instead of the hard disk drive 108. The set of data is read directly from the solid state drive 106 to increase speed and performance of the read operation.

The plurality of read/write requests generated for the set of data are served by the random access memory 104. The random access memory 104 serves the plurality of read/write requests and returns control to the application 102. Further, the plurality of read/write requests generated for the set of data are served by the solid state drive 106 rather than the hard disk drive 108 of the computer system. The plurality of read/write requests generated for the set of data are served by the solid state drive 106 if the set of data is not found in the random access memory 104 of the computer system. Furthermore, the plurality of read/write requests generated for the set of data are served by the hard disk drive 108 of the computer system. The plurality of read/write requests generated for the set of data are served by the hard disk drive 108 if the set of data is not found in the solid state drive 106.

In an example, a read request from the plurality of read/write requests occur at the I/O layer 106a of the solid state drive 106. The solid state drive 106 reads the set of data from the solid state drive 106 instead of the hard disk drive 108. Further, the solid state drive 106 reads the set of data from the hard disk drive 108 if the set of data is not found in the solid state drive 106. In another example, a write request from the plurality of read/write requests occur at the I/O layer 106a of the solid state drive 106. The solid state drive 106 writes the set of data to the solid state drive 106 directly instead of the hard disk drive 108. Further, the solid state drive 106 flushes the set of data to the hard disk drive 108 if there is no space in the solid state drive 106.

In an embodiment of the present disclosure, the pre-defined criteria includes writing the set of data in the solid state drive pool 106b present in the solid state drive 106. The pre-defined criteria include flushing the set of data in the hard disk drive 108. The set of data is written in the solid state drive pool 106b if there is no space in the buffer pool 104b present in the random access memory 104. The set of data is flushed to the hard disk drive 108 if there is no space in the solid state drive pool 106b.

In an embodiment of the present disclosure, the pre-defined criteria includes reading the set of data from the solid state drive pool 106b present in the solid state drive 106. The pre-defined criteria include reading the set of data from the hard disk drive 108. The set of data is read from the solid state drive pool 106b if the set of data is present in the solid state drive pool 106b. The set of data is read from the hard disk drive 108 if the set of data is not present in the solid state drive pool 106b.

In an embodiment of the present disclosure, the plurality of read/write requests generated by the application 102 are always served by the solid state drive 106 before occurring at the hard disk drive 108. In general, the plurality of read/write requests generated by the application 102 is always served by the random access memory 104 of the computer system. Further, the plurality of read/write requests is served by the hard disk drive 108 if the set of data requested is not found in the random access memory 104. In an embodiment of the present disclosure, the plurality of read/write requests are served by the solid state drive 106 before occurring at the hard disk drive 108. The plurality of read/write requests are served by the hard disk drive 108 only if the set of data requested is not found in the solid state drive 106.

In an embodiment of the present disclosure, the solid state drive 106 as extension of the random access memory 104 has various advantages. The solid state drive 106 increases speed and performance of the computer system. The solid state drive 106 is faster than the hard disk drive 108 due to no mechanical seeks. In addition, the solid state drive 106 is better than the hard disk drive 108 due to a plurality of reasons. The plurality of reasons includes 2× more bandwidth than the hard disk drive 108, easy implementation as block device and the like. Moreover, the solid state drive 106 is cheaper than the random access memory 104. The advantages of the solid state drive 106 makes the solid state drive 106 best option to act as extension of the random access memory 104.

In an example, a computer presently without a solid state drive uses Z amount of the random access memory 104 for processing data. The computer may then use X amount of the solid state drive 106 and Y amount of the random access memory 104. The cost of X amount of the solid state drive 106 and Y amount of the random access memory 104 combined is drastically less than Z amount of the random access memory 104. So, it is better option to deploy the solid state drive 106 as extension of the random access memory 104.

In an embodiment of the present disclosure, the I/O layer 106a programmed on top of the solid state drive 106 writes the set of data to the solid state drive 106 in sequential manner. The set of data is written sequentially to the solid state drive 106 to increase lifetime of the solid state drive 106. In an example, the solid state drive 106 is based on NAND-gate technology. Each read/write operation on the solid state drive 106 requires erasing of already present data in each cell and writing new data to each cell. The random writing of data to each cell of the solid state drive 106 reduces lifecycle of the solid state drive 106. Therefore, the I/O layer 106a is programmed to read/write the set of data in the solid state drive 106 in sequential manner. In another embodiment of the present disclosure, the I/O layer 106a programmed on top of the solid state drive 106 writes the set of data to the solid state drive 106 in random manner.

In an embodiment of the present disclosure, the solid state drive 106 deployed as extension of the random access memory 104 provides elasticity. In an example, we need to add same amount of the random access memory 104 for every byte of data that is to be handled by the random access memory 104. But the random access memory 104 is costlier and it is not practically possible always to install complete amount of the random access memory 104 for every byte of data generated. Therefore, we implement the solid state drive 106 as extension of the already installed random access memory 104 to provide better elasticity.

In an embodiment of the present disclosure, the solid state drive 106 exposes similar interfaces as the random access memory 104. In an example, the solid state drive 106 exposes interfaces such as malloc( ), new( ) and like. In an embodiment of the present disclosure, the solid state drive 106 is log structured in nature. In an embodiment of the present disclosure, objects of any size may be used with the solid state drive 106.

In an embodiment of the present disclosure, the solid state drive 106 is deployed in extension with the random access memory 104 in systems that use technologies which deal with large amount of data. The technologies may include Artificial Intelligence, Big Data, Machine learning, Internet of things, data analytics, data processing, security applications and the like. The above mentioned technologies consume and interact with large amount of data. In an embodiment of the present disclosure, the solid state drive 106 is deployed as extension of the random access memory 104 in large servers and distributed processing computer systems.

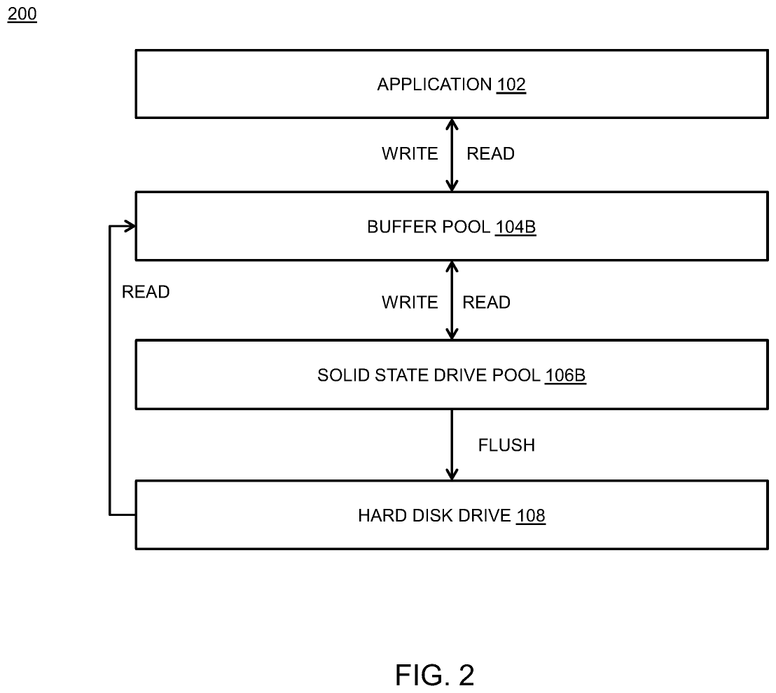

FIG. 2 illustrates an interaction 200 between the application 102, the random access memory 104, the solid state drive 106 and the hard disk drive 108, in accordance with various embodiments of the present disclosure. The application 102 performs the plurality of read/write requests for the set of data with the random access memory 104. The plurality of read/write requests for the set of data performed by the application 102 are always served by the random access memory 104. The plurality of read/write requests are always served by the random access memory 104 because the random access memory 104 is the fastest memory. In addition, the plurality of read/write requests is served by the buffer pool 104b present in the random access memory 104.

Further, the plurality of read/write requests for the set of data are served by the I/O layer 106a of the solid state drive 106 if the plurality of read/write requests is not served by the buffer pool 104b of the random access memory 104. Moreover, the set of data is read from the solid state drive 106 if the set of data is not found in the buffer pool 104b of the random access memory 104. Also, the set of data is written in the solid state drive 106 if there is no space in the buffer pool 104b of the random access memory 104. In addition, the plurality of read/write requests are served by the solid state drive pool 106b present in the solid state drive 106.

In addition, the set of data is flushed in the hard disk drive 108 from the solid state drive pool 106b. The set of data is flushed in the hard disk drive 108 pool if there is no space in the solid state drive pool 106b. The hard disk drive 108 reads data from the buffer pool 104b of the random access memory 104 directly. In an embodiment of the present disclosure, the hard disk drive 108 reads data from the solid state drive pool 106b of the solid state drive 106.

In an embodiment of the present disclosure, the flushing of a set of pages to the hard disk drive 108 from the solid state drive pool 106b includes a first step of checking if the solid state drive 106 is full. The method includes a second step of locking the solid state drive pool 106b. The method includes a third step of executing second last step. The method includes a fourth step of computing size of the solid state drive pool 106b to be flushed to the hard disk drive 108. The method includes a fifth step of collecting a set of headers from LRU for size. The method includes a sixth step of resetting EOF and other pointers to pages. The method includes a seventh step of marking chunk of area to be flushed. The method includes an eighth step of copying chunk of area to another temp memory. The method includes a ninth step of removing the set of headers from hash table and LRU. The method includes a tenth step of unlocking the solid state drive pool 106b for appends only. The method includes an eleventh step of sorting the set of headers by sum of FILE ID and BLOCK ID. The method includes a twelfth step of doing vector write of all pages to the hard disk drive 108. The method includes a thirteenth step of returning number of the set of headers flushed. The method includes a fourteenth step of unlocking the solid state drive pool 106b for read. The method includes a fifteenth step of sleeping if it is background work. The method includes a sixteenth step of repeating above mentioned steps. The solid state drive pool 106b is locked if the solid state drive 106 is full. The fifteenth step is executed if the solid state drive pool 106b is not full.

In an embodiment of the present disclosure, the writing of the set of headers to the solid state drive pool 106b includes a first step of checking whether the buffer pool 104b is full. The method includes another step of locking the buffer pool 104b. The method includes yet another step of executing second last step. The method includes yet another step of collecting the set of headers from LRU with DP mark. The method includes yet another step of repeating steps of flushing of the set of pages to the hard disk drive 108 from the solid state drive pool 106b. The method includes yet another step of checking if there is enough space in the solid state drive pool 106b. The method includes yet another step of locking the solid state drive pool 106b for write. The method includes yet another step of repeating steps of flushing of the set of pages to the hard disk drive 108 from the solid state drive pool 106b. The method includes yet another step of appending the solid state drive pool 106b area for given size. The method includes yet another step of resetting the set of pointers. The method includes yet another step of putting the set of headers in hash table. The method includes yet another step of putting the set of headers in LRU list. The method includes yet another step of unlocking the solid state drive pool 106b for write. The method includes yet another step of returning n headers to BP_BW. The method includes yet another step of sleeping. The method includes yet another step of repeating above mentioned steps. The buffer pool 104b is locked if the buffer pool 104b is full. The second last step is executed if the buffer pool 104b is not full. The solid state drive pool 106b is locked if there is enough space in the solid state drive pool 106b. The steps of flushing of the set of pages to the hard disk drive 108 from the solid state drive pool 106b are repeated if there is not enough space in the solid state drive pool 106b.

In an embodiment of the present disclosure, the set of pages are written in random manner in the random access memory 104. In an embodiment of the present disclosure, the set of pages are written to the solid state drive 106 from the buffer pool 104b in case of overflow. In an embodiment of the present disclosure, dirty pages are stored in DP list. In addition, the reclaim occurs for both non dirty and dirty pages. Also, dirty pages are written to the solid state drive 106 instead of the hard disk drive 108. In an embodiment of the present disclosure, the set of headers are written directly to the solid state drive pool 106b without sorting the set of pages. In an embodiment of the present disclosure, a background worker in the buffer pool 104b retains ensures proper working of the buffer pool 104b present in the random access memory 104.

In an embodiment of the present disclosure, the set of pages are flushed to the hard disk drive 108 from the solid state drive pool 106b in case of overflow. In an embodiment of the present disclosure, the solid state drive pool 106b fetch data about dirty pages from DP list present in the buffer pool 104b. In an embodiment of the present disclosure, a background worker in the solid state drive pool 106b retains sorts and flushes the set of pages on the hard disk drive 108.

The solid state drive 106 is integrated with the buffer pool 104b of the database 104a. Further, the set of data is read or written to the solid state drive 106 directly instead of the hard disk drive 108. The set of data is read or written to the solid state drive pool 106b of the solid state drive 106. Further, the set of data is read or written to the hard disk drive 108 if the set of data is not found in the solid state drive 106.

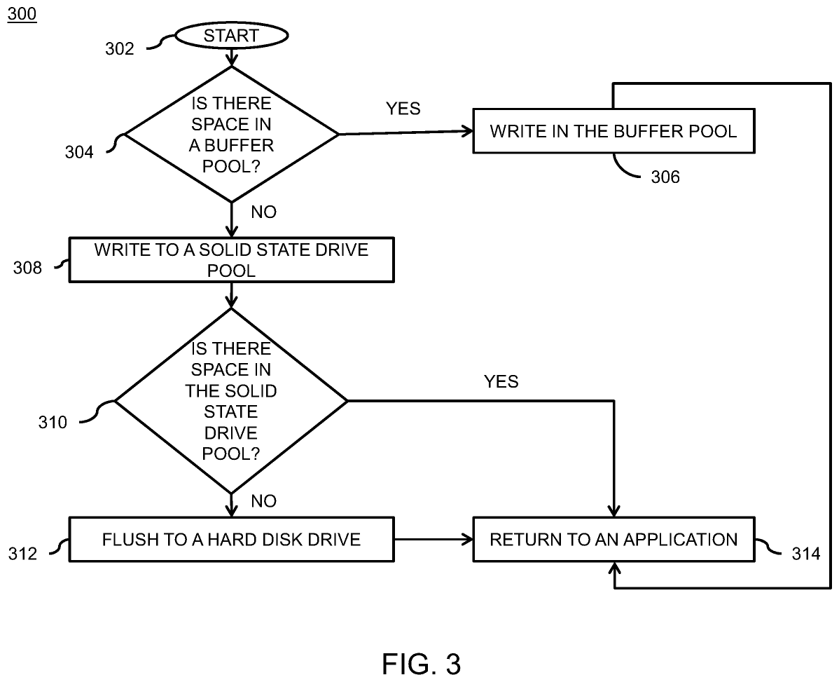

FIG. 3 illustrates a flow chart 300 for performing a method for write request on the set of data, in accordance with various embodiments of the present disclosure. It may be noted that to explain the process steps of flowchart 300, references will be made to the system elements of FIG. 1 and FIG. 2.

The flowchart 300 initiates at step 302. Following step 302, at step 304, it is checked if there is space in the buffer pool 104b. If there is space in the buffer pool 104b, at step 306, a command for writing the set of data in the buffer pool 104b is issued. Further, at step 314, a command is issued to return to the application 102. If there is no space in the buffer pool 104b, at step 308, a command for writing the set of data in the solid state drive pool 106b is issued. Further, at step 310, it is checked if there is space in the solid state drive pool 106b. If there is space in the solid state drive pool 106b, at step 314, a command is issued to return to the application 102. If there is no space in the solid state drive pool 106b, then at step 312, a command is issued to flush the set of data to the hard disk drive 108. At step 314, a command is issued to return to the application 102.

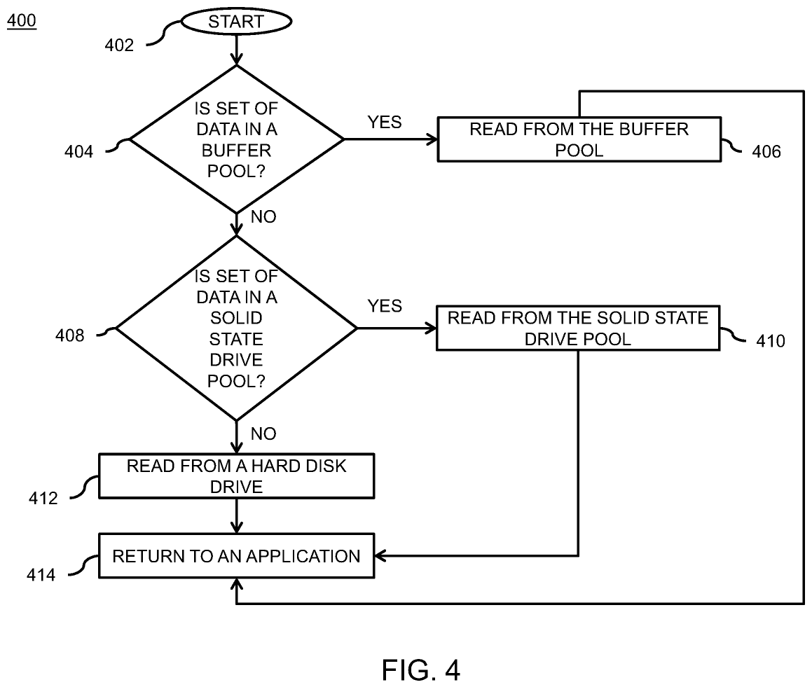

FIG. 4 illustrates a flow chart 400 for performing a method for read request on the set of data, in accordance with various embodiments of the present disclosure. It may be noted that to explain the process steps of flowchart 400, references will be made to the system elements of FIG. 1 and FIG. 2.

The flowchart 400 initiates at step 402. Following step 402, at step 404, it is checked if the set of data is there in the buffer pool 104b. If the set of data is found in the buffer pool 104b, at step 406, a command for reading the set of data from the buffer pool 104b is issued. Further, at step 414, a command is issued to return to the application 102. If there is no space in the buffer pool 104b, at step 408, it is checked if the set of data is there in the solid state drive pool 106b. If the set of data is found at the solid state drive pool 106b, at step 410, a command is issued to read the set of data from the solid state drive pool 106b. Further, at step 414, a command is issued to return to the application 102. If the set of data is not found in the solid state drive pool 106b, at step 412, a command is issued to read the set of data from the hard disk drive 108. At step 414, a command is issued to return to the application 102.

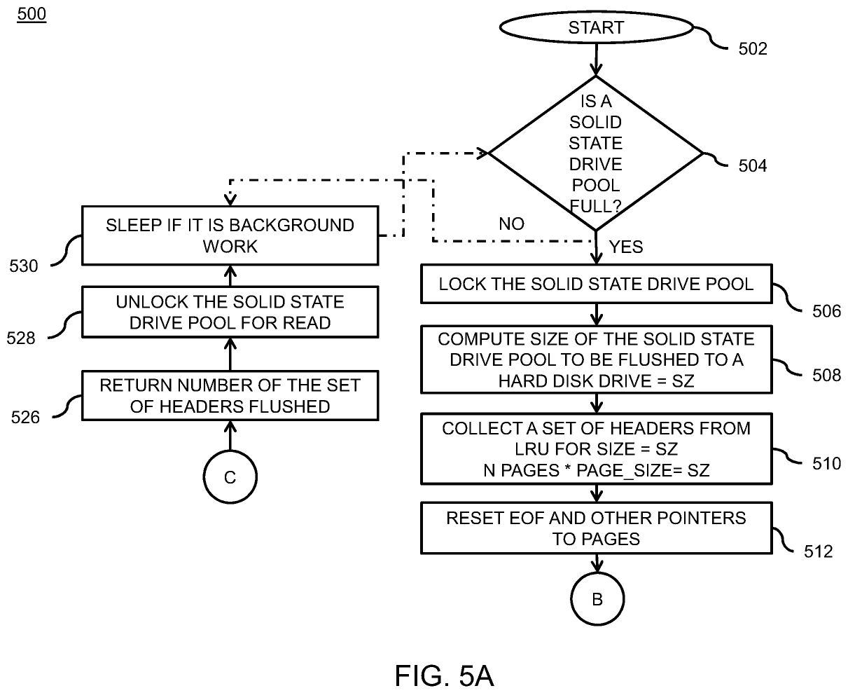

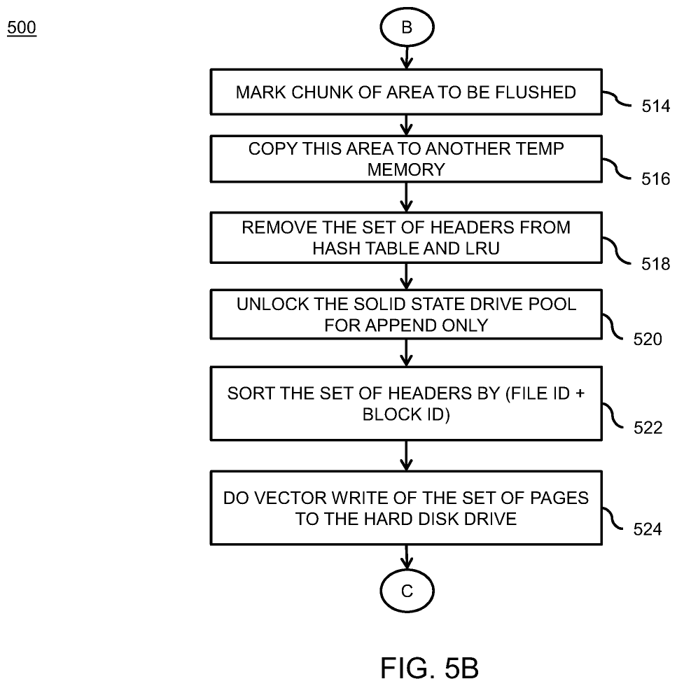

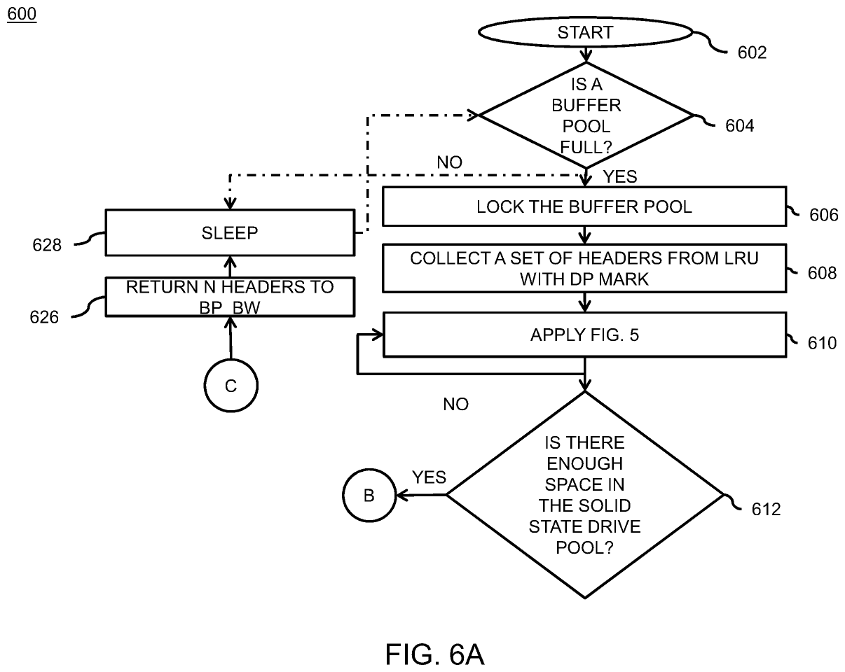

FIGS. 5A and 5B illustrate a flow chart 500 for flushing the set of pages from the solid state drive pool 106b to the hard disk drive 108, in accordance with various embodiments of the present disclosure. It may be noted that to explain the process steps of flowchart 500, references will be made to the system elements of FIG. 1 and FIG. 2 and the process steps of flowchart 300 of FIG. 3 and flowchart 400 of FIG. 4.

The flowchart 500 initiates at step 502. Following step 502, at step 504, it is checked if the solid state drive pool 106b is full. If the solid state drive pool 106b is not full, at step 530, a command to sleep if it is background work is issued. If the solid state drive pool 106b is full, at step 506, a command to lock the solid state drive pool 106b is issued. Further, at step 508, a command is issued to compute size of the solid state drive pool 106b to be flushed to the hard disk drive 108=“SZ”. Further, at step 510, a command is issued to collect the set of headers from LRU for size=“SZ” “N PAGES*PAGE_SIZE=SZ”. At step 512, a command to reset EOF and other pointers to pages is issued. At step 514, a command to mark chunk of area to be flushed is issued. At step 516, a command to copy the marked chunk of area to another temp memory is issued. Further, at step 518, a command is issued to remove the set of headers from hash table and LRU. Furthermore, at step 520, a command is issued to unlock the solid state drive pool 106b for append only. At step 522, a command is issued to sort the set of headers by sum of FILE ID and BLOCK ID. At step 524, a command is issued to do vector write of the set of pages to the hard disk drive 108. At step 526, a command is issued to return number of the set of headers flushed. Further, at step 528, a command to unlock the solid state drive pool 106b for read is issued. Furthermore, at step 530, a command to sleep if it is background work is issued and the process is returned to step 504.

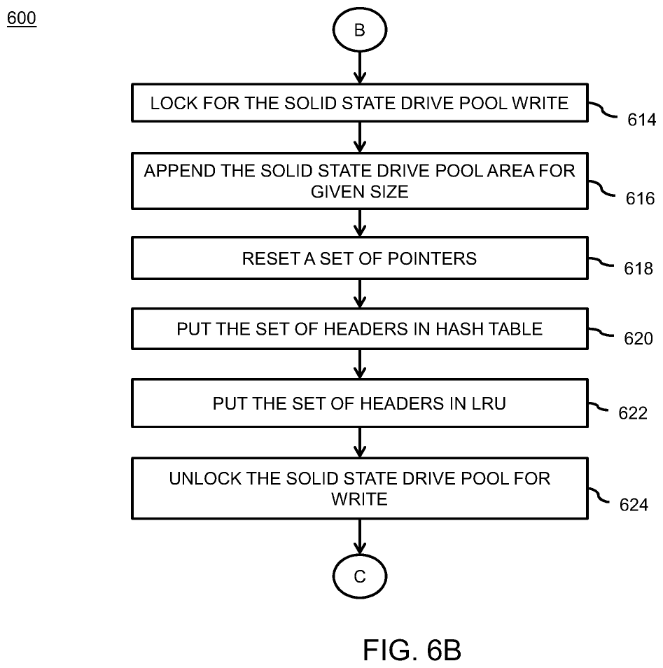

FIGS. 6A and 6B illustrate a flow chart 600 for flushing the set of headers to the solid state drive pool 106b, in accordance with various embodiments of the present disclosure. It may be noted that to explain the process steps of flowchart 600, references will be made to the system elements of FIG. 1 and FIG. 2 and the process steps of flowchart 300 of FIG. 3, flowchart 400 of FIG. 4 and flowchart 500 of FIGS. 5A and 5B.

The flowchart 600 initiates at step 602. Following step 602, at step 604, it is checked if the buffer pool 104b is full. If the buffer pool 104b is not full, at step 628, a command to sleep is issued. If the buffer pool 104b is full, at step 606, a command to lock the buffer pool 104b is issued. Further, at step 608, a command is issued to collect the set of headers from LRU with DP mark. Further, at step 610, a command is issued to apply steps 502-530 of FIGS. 5A and 5B. At step 612, it is checked if there is enough space in the solid state drive pool 106b. If there is not enough space in the solid state drive pool 106b, the process is returned to step 610. If there is enough space in the solid state drive pool 106b, at step 614, a command to lock for the solid state drive pool 106b write is issued. At step 616, a command to append the solid state drive pool 106b area for given size is issued. Further, at step 618, a command is issued to reset a set of pointers. Furthermore, at step 620, a command is issued to put the set of headers in hash table. At step 622, a command is issued to put the set of headers in LRU. At step 624, a command is issued to unlock the solid state drive pool 106b for write. At step 626, a command is issued to return N headers to “BP_BW”. Further, at step 628, a command to sleep is issued and the process is returned to step 604.

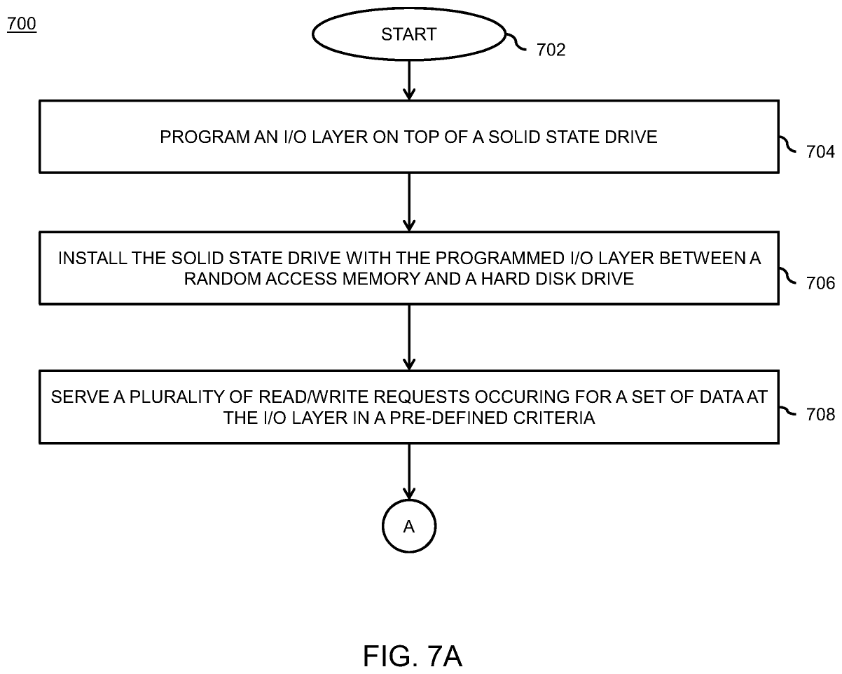

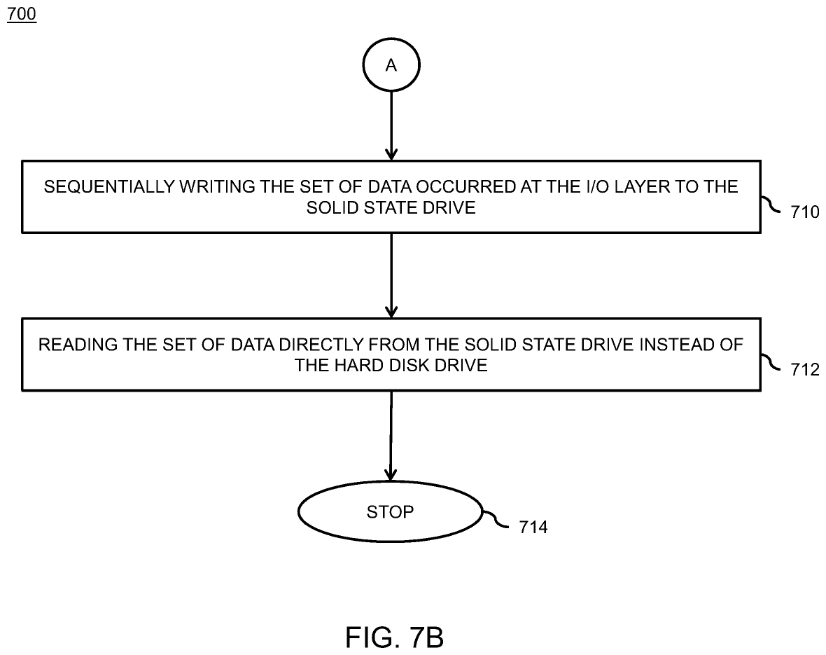

FIGS. 7A and 7B illustrate a flow chart 700 for deploying the solid state drive 106 as extension of the already installed random access memory 104, in accordance with various embodiments of the present disclosure. It may be noted that to explain the process steps of flowchart 700, references will be made to the system elements of FIG. 1 and FIG. 2. It may also be noted that the flowchart 700 may have lesser or more number of steps.

The flowchart 700 initiates at step 702. Following step 702, at step 704, the I/O layer 106a is programmed on top of the solid state drive 106. At step 706, the solid state drive 106 with the programmed I/O layer 106a is installed between the random access memory 104 and the hard disk drive 108. At step 708, the plurality of read/write requests occurring for the set of data at the I/O layer 106a are served in the pre-defined criteria. At step 710, the set of data occurred at the I/O layer 106a is sequentially written to the solid state drive 106 At step 712, the set of data is read directly from the solid state drive 106 instead of the hard disk drive 108 The flow chart 700 terminates at step 714.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

While several possible embodiments of the invention have been described above and illustrated in some cases, it should be interpreted and understood as to have been presented only by way of illustration and example, but not by limitation. Thus, the breadth and scope of a preferred embodiment should not be limited by any of the above-described exemplary embodiments.

We claim:

1. A computer-implemented method for expansion of a random access memory by deploying a solid state drive in extension with the already installed random access memory, wherein the solid state drive is deployed in extension with the random access memory to reduce hardware cost and increase elasticity, the computer-implemented method comprising:
programming an I/O layer on top of the solid state drive, wherein the I/O layer is used to handle a plurality of read/write requests for a set of data, wherein the I/O layer handles the plurality of read/write requests using one or more background threads;
installing the solid state drive with the programmed I/O layer between the random access memory and a hard disk drive, wherein the solid state drive acts as extension of the already installed random access memory;
serving the plurality of read/write requests occurring for the set of data at the I/O layer in a pre-defined criteria, wherein the plurality of read/write requests are served based on a plurality of prediction algorithms, wherein the pre-defined criteria comprises:
sequentially writing the set of data occurred at the I/O layer to the solid state drive, wherein the set of data is written sequentially to the solid state drive to increase life cycle of the solid state drive; and
reading the set of data directly from the solid state drive instead of the hard disk drive, wherein the set of data is read directly from the solid state drive to increase speed and performance of read operation.

2. The computer-implemented method as recited in claim 1, wherein the pre-defined criteria further comprises:
writing the set of data in a solid state drive pool present in the solid state drive, wherein the set of data is written in the solid state drive pool if there is no space in a buffer pool present in the random access memory, and
flushing the set of data in the hard disk drive, wherein the set of data is flushed to the hard disk drive if there is no space in the solid state drive pool.

3. The computer-implemented method as recited in claim 1, wherein the pre-defined criteria further comprises:
reading the set of data from the solid state drive pool present in the solid state drive, wherein the set of data is read from the solid state drive pool if the set of data is present in the solid state drive pool; and
reading the set of data from the hard disk drive, wherein the set of data is read from the hard disk drive if the set of data is not present in the solid state drive pool.

4. The computer-implemented method as recited in claim 2, wherein the flushing of a set of pages to the hard disk drive from the solid state drive pool further comprises:
A. checking if the solid state drive is full;
B. locking the solid state drive pool, wherein the solid state drive pool is locked if the solid state drive is full;
C. executing step O, wherein step O is executed if the solid state drive pool is not full;
D. computing size of the solid state drive pool to be flushed to the hard disk drive;
E. collecting a set of headers from LRU for size;
F. resetting EOF and other pointers to pages;
G. marking chunk of area to be flushed;
H. copying chunk of area to another temp memory;
I. removing the set of headers from hash table and LRU;
J. unlocking the solid state drive pool for append only;
K. sorting the set of headers by sum of FILE ID and BLOCK ID;
L. doing vector write of all pages to the hard disk drive;
M. returning number of the set of headers flushed;
N. unlocking the solid state drive pool for read;
O. sleeping if it is background work; and
P. repeating steps A-O.

5. The computer-implemented method as recited in claim 2, wherein writing of the set of headers to the solid state drive pool further comprises:
A. checking whether the buffer pool is full;
B. locking the buffer pool, wherein the buffer pool is locked if the buffer pool is full;
C. executing step O, wherein step O is executed if the buffer pool is not full;
D. collecting the set of headers from LRU with DP mark;
E. repeating steps A-P from claim 4;
F. checking if there is enough space in the solid state drive pool;
G. locking the solid state drive pool for write, wherein the solid state drive pool is locked if there is enough space in the solid state drive pool;
H. repeating steps A-P from claim 4, wherein steps A-P from claim 4 are repeated if there is not enough space in the solid state drive pool;
I. appending the solid state drive pool area for given size;
J. resetting set of pointers;
K. putting the set of headers in hash table;
L. putting the set of headers in LRU list;
M. unlocking the solid state drive pool for write;
N. returning n headers to BP_BW;
O. sleeping; and
P. repeating steps A-O.

6. The computer-implemented method as recited in claim 1, wherein size of the solid state drive should be less than 16× of size of the random access memory to get performance of 4× of size of the random access memory.

7. The computer-implemented method as recited in claim 1, wherein life of the solid state drive is extended below range of 16× or 32×.

8. The computer-implemented method as recited in claim 1, wherein the solid state drive of any size is deployed in extension with the random access memory of any size.

9. The computer-implemented method as recited in claim 1, wherein the plurality of prediction algorithms comprise of absolute prediction, heuristic based prediction and machine learning based prediction.

10. A computer system comprising:
a random access memory;
a hard disk drive; and
a solid state drive, wherein the solid state drive is deployed to act as extension of the already installed random access memory, wherein the solid state drive is deployed to work in background with the random access memory, wherein the solid state drive acts as extension to the already installed random access memory by performing a method, the method comprising:
programming an I/O layer on top of the solid state drive, wherein the I/O layer is used to handle a plurality of read/write requests for a set of data, wherein the I/O layer handles the plurality of read/write requests using one or more background threads;
installing the solid state drive with the programmed I/O layer between the random access memory and the hard disk drive, wherein the solid state drive acts as extension of the already installed random access memory;
serving the plurality of read/write requests occurring for the set of data at the I/O layer in a pre-defined criteria, wherein the plurality of read/write requests are served based on a plurality of prediction algorithms, wherein the pre-defined criteria comprises:
sequentially writing the set of data occurred at the I/O layer to the solid state drive, wherein the set of data is written sequentially to the solid state drive to increase life cycle of the solid state drive; and
reading the set of data directly from the solid state drive instead of the hard disk drive, wherein the set of data is read directly from the solid state drive to increase speed and performance of read operation.

11. The computer system as recited in claim 10, wherein the pre-defined criteria further comprises:
writing the set of data in a solid state drive pool present in the solid state drive, wherein the set of data is written in the solid state drive pool if there is no space in a buffer pool present in the random access memory, and
flushing the set of data in the hard disk drive, wherein the set of data is flushed to the hard disk drive if there is no space in the solid state drive pool.

12. The computer system as recited in claim 10, wherein the pre-defined criteria further comprises:
reading the set of data from the solid state drive pool present in the solid state drive, wherein the set of data is read from the solid state drive pool if the set of data is present in the solid state drive pool; and
reading the set of data from the hard disk drive, wherein the set of data is read from the hard disk drive if the set of data is not present in the solid state drive pool.

13. The computer system as recited in claim 11, wherein the flushing of a set of pages to the hard disk drive from the solid state drive pool further comprises:
A. checking if the solid state drive is full;
B. locking the solid state drive pool, wherein the solid state drive pool is locked if the solid state drive is full;
C. executing step O, wherein step O is executed if the solid state drive pool is not full;
D. computing size of the solid state drive pool to be flushed to the hard disk drive;
E. collecting a set of headers from LRU for size;
F. resetting EOF and other pointers to pages;
G. marking chunk of area to be flushed;
H. copying chunk of area to another temp memory;
I. removing the set of headers from hash table and LRU;
J. unlocking the solid state drive pool for append only;
K. sorting the set of headers by sum of FILE ID and BLOCK ID;
L. doing vector write of all pages to the hard disk drive;
M. returning number of the set of headers flushed;
N. unlocking the solid state drive pool for read;
O. sleeping if it is background work; and
P. repeating steps A-O.

14. The computer-implemented method as recited in claim 11, wherein writing of the set of headers to the solid state drive pool further comprises:
A. checking whether the buffer pool is full;
B. locking the buffer pool, wherein the buffer pool is locked if the buffer pool is full;
C. executing step O, wherein step O is executed if the buffer pool is not full;
D. collecting the set of headers from LRU with DP mark;
E. repeating steps A-P from claim 13;
F. checking if there is enough space in the solid state drive pool;
G. locking the solid state drive pool for write, wherein the solid state drive pool is locked if there is enough space in the solid state drive pool;
H. repeating steps A-P from claim 13, wherein the steps A-P from claim 13 are repeated if there is not enough space in the solid state drive pool;
I. appending the solid state drive pool area for given size;
J. resetting set of pointers;
K. putting the set of headers in hash table;
L. putting the set of headers in LRU list;
M. unlocking the solid state drive pool for write;
N. returning n headers to BP_BW;
O. sleeping; and
P repeating steps A-O.

15. The computer system as recited in claim 10, wherein size of the solid state drive should be less than 16× of size of the random access memory to get performance of 4× of size of the random access memory.

16. The computer system as recited in claim 10, wherein life of the solid state drive is extended below range of 16× or 32×.

17. The computer system as recited in claim 10, wherein the plurality of prediction algorithms comprise of absolute prediction, heuristic based prediction and machine learning based prediction.

18. A non-transitory computer readable storage medium encoding computer executable instructions that, when executed by at least one processor, performs a method for expansion of a random access memory by deploying a solid state drive in extension with the already installed random access memory, wherein the solid state drive is deployed in extension with the random access memory to reduce cost and increase elasticity, the method comprising:
programming an I/O layer on top of the solid state drive, wherein the I/O layer is used to handle a plurality of read/write requests for a set of data, wherein the I/O layer handles the plurality of read/write requests using one or more background threads, wherein the one or more background threads are used to write the set of data in the solid state drive from the random access memory;
installing the solid state drive with the programmed I/O layer between the random access memory and a hard disk drive, wherein the solid state drive acts as extension of the already installed random access memory;
serving the plurality of read/write requests occurring for the set of data at the I/O layer in a pre-defined criteria, wherein the plurality of read/write requests are served based on a plurality of prediction algorithms, wherein the plurality of prediction algorithms comprise of absolute prediction, heuristic based prediction and machine learning based prediction, wherein the plurality of read/write requests are served at the I/O layer of the solid state drive, wherein the pre-defined criteria comprises:
sequentially writing the set of data occurred at the I/O layer to the solid state drive, wherein the set of data is written sequentially to the solid state drive to increase life cycle of the solid state drive; and
reading the set of data directly from the solid state drive instead of the hard disk drive, wherein the set of data is read directly from the solid state drive to increase speed and performance of read operation.

19. The non-transitory computer readable storage medium as recited in claim 18, wherein the pre-defined criteria further comprises:
writing the set of data in a solid state drive pool present in the solid state drive, wherein the set of data is written in the solid state drive pool if there is no space in a buffer pool present in the random access memory, and
flushing the set of data in the hard disk drive, wherein the set of data is flushed to the hard disk drive if there is no space in the solid state drive pool.

20. The non-transitory computer readable storage medium as recited in claim 18, wherein the pre-defined criteria further comprises:
reading the set of data from the solid state drive pool present in the solid state drive, wherein the set of data is read from the solid state drive pool if the set of data is present in the solid state drive pool; and
reading the set of data from the hard disk drive, wherein the set of data is read from the hard disk drive if the set of data is not present in the solid state drive pool.
